(19) United States
(12) Patent Application Publication
(10) Pub. No.: US 2014/0122376 A1
(43) Pub. Date: May 1, 2014

(54) Method of preparing and using an armored truck as a mobile assaying platform

(71) Applicant: Chris M. Noyes, Virginia Beach, VA (US)

(72) Inventor: Chris M. Noyes, Virginia Beach, VA (US)

(21) Appl. No.: 13/136,803

(22) Filed: Aug. 11, 2011

(51) Int. Cl. G06Q 90/00; B23P 19/00

(52) U.S. Cl. 705/500; 29/426.2

(57) ABSTRACT

There is provided a method for modifying an armored truck to create a self-contained, mobile smelting and assaying facility for the processing of precious metals. There is further provided a method for using the mobile facility to visit a client site, receive precious metal from the client, smelt the metal, pour an ingot therefrom, assay the ingot and pay the client for the received precious metal based on a current market price obtained within the mobile facility. A security/surveillance system included interior and exterior cameras whose images are both recorded and transmitted to a remote location. The communications system provides continuous Internet access within the facility.

### RELATED APPLICATIONS

This application is related to U.S. patent application Ser. No. ______ titled MOBILE ASSAY FACILITY AND METHOD OF USING TO PROCURE AND ASSAY PRECIOUS METALS filed concurrently herewith and included herein in its entirety by reference. This included by reference application is referred to hereinafter as “our co-pending, included application.”

### FIELD OF THE INVENTION

This invention pertains to facilities for assaying precious metals and, more particularly, to a secure, mobile, self-contained assay facility and a method of preparing an armored truck to house such a facility and a method of using the facility to procure, assay, and process gold and other precious metals.

### BACKGROUND OF THE INVENTION

The increasing demand for gold and other precious metals for industrial processes, investments, and other uses has caused the market prices for such metals to increase to record levels. The high market price of gold has prompted owners of unused, unwanted jewelry to sell that jewelry through brokers such as pawn shops, jewelry stores, and other establishments equipped to purchase such used jewelry from the public. As used herein, the term pawn shop will be used to refer to any and all such receivers of precious metals. Further, for simplicity, the term gold will be assumed to include other precious metals such as, but not limited to, silver, platinum, copper, etc.

After the pawn shop has purchased gold, most likely as assorted jewelry from several individual sellers, the pawn shop must either smelt the gold they have purchased or sell the gold as is to a processor of precious metals.

### SUMMARY OF THE INVENTION

In accordance with the present invention there is provided a method of preparing an armored truck for use as a mobile smelting and assaying facility. An armored truck is modified by removing interior structural features such as ceiling panels, wall panels, and any other interior structural features that would interfere with the use of the armored truck as a mobile smelting and assaying facility.

The armored truck's roof is raised, typically approximately two feet. An upper skirt is installed on the roof to protect equipment mounted on the roof. Roof-mounted equipment includes a diesel generator, an air compressor, and a portion of a ventilation system. A ladder allowing access to the roof is also added to the armored truck.

An auxiliary fuel tank may be added to extend the range of operation on the mobile smelting and assaying facility as well as to provide fuel to the diesel generator.

Interior cabinets, work surfaces and other structural features are fabricated and installed in the cargo portion of the armored truck. Smelting and assaying equipment including an induction furnace including a water cooling system, a precision scale, an ingot quench tank, X-ray fluorescence (XRF) analyzer, and a computer system are also installed.

A safe may be fabricated and installed in the cargo portion of the armored truck.

Finally, a sophisticated security/surveillance system and communications system is installed in the truck. The communications system provides a substantially continuous communications with a remote location (e.g., an Assay on Wheels™ (AOW) office) and provides Internet access within the self-contained, mobile smelting and assaying facility.

Once the modified armored truck is complete and stocked with necessary operational supplies, it may be driven to client facilities where precious metal is received from the client, smelted, poured into one or more ingots, analyzed, and purchased from the client. Payment may preferably be made to the client by wire transfer initiated from within the modified armored truck. Alternately, the client may be paid in cash dispensed by a cash dispenser, in gold or silver bullion, or by another method mutually acceptable to the client and the truck operator.

It is, therefore, an object of the invention to provide a method for modifying an armored truck to create a self-contained mobile smelting and assaying facility.

It is another object of the invention to provide a method for modifying an armored truck to create a self-contained mobile smelting and assaying facility wherein the armored truck is modified by raising the roof thereof.

It is an additional object of the invention to provide a method for modifying an armored truck to create a self-contained mobile smelting and assaying facility wherein an armored truck is modified by adding an upper skirt, a diesel powered generator and an air compressor to the roof of the armored truck.

It is a further object of the invention to provide a method for modifying an armored truck to create a self-contained mobile smelting and assaying facility wherein an armored truck is modified by installing smelting and assaying equipment including an induction furnace, a precision scale, an X-ray fluorescence (XRF) analyzer, a quench tank, a computer system, and a cash dispenser in a cargo portion of the armored truck.

It is a still further object of the invention to provide a method for modifying an armored truck to create a self-contained mobile smelting and assaying facility wherein an armored truck is modified by installing a sophisticated security/surveillance and communications system thereto.

It is yet another object of the invention to provide a method for operating a self-contained mobile smelting and assaying facility to procure precious metal offered by a client, smelting and assaying the procured precious metal, and paying the client for the precious metal based on the market price of the precious metal.

It is another object of the invention to provide a method for operating a self-contained mobile smelting and assaying facility wherein the mobile facility is driven to a client site.

It is an additional object of the invention to provide a method for operating a self-contained mobile smelting and assaying facility wherein a wire transfer paying for procured precious metal may be initiated and confirmed from the mobile facility.

It is a further object of the invention to provide a method for operating a self-contained mobile smelting and assaying facility wherein a security/surveillance system monitors all activities within and around the facility and imagery from the security/surveillance system is recorded and transmitted to a base of operations.

It is a still further object of the invention to provide a method for operating a self-contained mobile smelting and assaying facility wherein all weighing, smelting, and assaying operations are done so as to be readily observable by a client seated within the mobile facility.

It is yet another object of the invention to provide a method for operating a self-contained mobile smelting and assaying facility wherein smelted procured precious metal may be stored in a safe therein or shipped directly from the mobile facility via a carrier such as FedEx®.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a flow chart of the process of modifying an armored truck into a self-contained, mobile smelting and assaying facility;

FIGS. 2a and 2b show right side and rear elevational pictorial, views of an armored truck modified in accordance with the method of the invention for use as a self-contained, mobile smelting and assaying facility;

FIG. 3 is a flow chart of one aspect of operating the self-contained, mobile smelting and assaying facility constructed in accordance with the process of FIG. 1;

FIG. 4 is a simplified flow chart of the process of paying a clients for precious metal received therefrom;

FIG. 5 is a screen shot of an assay of an ingot formed as part of the method of FIG. 3; and

FIG. 6 is a form showing a typical settlement statement/value agreement form displaying information regarding the value and fees associated with precious metal being procured from a seller thereof in accordance with the method of FIG. 3.

### DETAILED DESCRIPTION OF THE PREFERRED EMBODIMENT

The present invention provides a method of modifying an armored vehicle to house a mobile smelting and assaying facility such as that described in our included co-pending application. In addition, a method of using the converted armored truck as a mobile smelting and assay facility is provided.

A modified armored truck has been found suitable for housing the mobile smelting and assaying facility discussed in detail in our included co-pending application. However, before an armored truck is suitable for use, it requires modification. The degree of modification will be determined by the current configuration of the armored truck. Either a new or used truck may be procured and modified. If new armored trucks are being procured, the truck may, of course, be ordered with a specific interior configuration that may require less modification than when a used truck is procured. If used trucks are being modified, the specific modifications will depend on the condition and configuration of the truck.

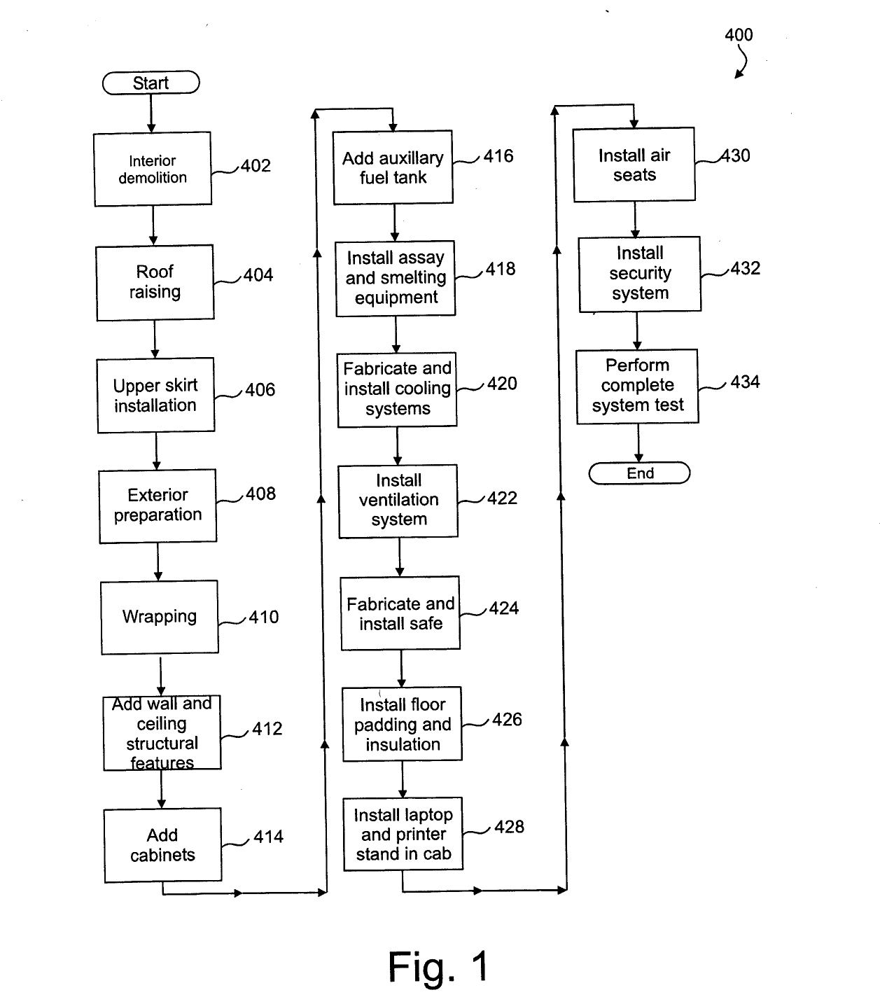

Referring first to FIG. 1, there is shown a flow chart illustrating the armored truck modification process, generally at reference number 400.

The first step in the modification process is inside demolition, block 402. Once an armored truck has been procured the rear of the truck may require gutting in anticipation of the upcoming interior modifications. Inside demolition involves removing any interior structures, as well as all interior wall and ceiling panels.

Once inside demolition, block 402, is complete the roof of the armored truck may be raised by a predetermined amount, block 404. The amount the roof is typically raiseD is approximately two feet. The raised roof allows the steps of the smelting and assaying processes, discussed in detail hereinbelow, to be performed without hindrance from a low interior ceiling. Roof raising, block 404, typically includes removing the existing roof using a plasma cutter or similar tool. Steel or other suitable material is then added to the body and the roof replaced. While raising the roof two feet has been specified for purposes of disclosure, it will be recognized that other amounts of rise may be substituted to accommodate a particular operating environment. Consequently, the invention is not considered limited to a particular roof raise. Rather, the invention is intended to include any practical amount of roof raise.

Once the roof is raised, block 404, an upper skirt is fabricated and installed atop the roof, block 406. The purpose of the upper skirt is to shield equipment installed on top of the truck roof from wind and debris damage. The upper skirt is formed from upright support posts, typically welded to the truck roof and skirting material attached to the upright posts. The skirting itself is typically 0.75 inch thick steel welded to the upright support posts.

A ladder allowing access to the armored truck's roof is also attached to the armored truck, typically on a surface thereof. It will, however, be recognized that the ladder may be attached elsewhere on outside surface of the armored truck.

Following upper skirt installation, block 406, the truck exterior is prepared for finishing, block 408. Exterior preparation typically includes installing reinforced hinges on doors, and sealing new welds with body filler such as Bondo® (a two-part body putty manufactured by 3M). When all such exterior body preparatory work is completed, the body is typically primed and painted.

Once the truck has been properly prepped, block 408, the process of wrapping the truck begins, block 410. A sticker wrap incorporating indicia such as advertising, company information including contact information, or other graphic or textual information is then placed over at least a portion of the truck's painted exterior surface. As discussed in our included co-pending application, the sticker wrap may contain misleading indicia to disguise the function of the truck as a mobile smelting and assay facility.

Once all exterior truck modifications are complete, the interior modifications to the truck are performed. While the modifications are presented as an ordered sequence of steps, it will be recognized that many of the steps may be performed asynchronously in orders other than the disclosed order. Consequently, the invention is not considered limited to the order in which the modification steps are specified for purposes of disclosure.

First, wall and ceiling structural features are added block 412. Wall and ceiling features include such items as wall and ceiling panels, conduit for electrical and data cables, hand rails used for entry/exit of the truck, and similar items.

Following wall and ceiling structural feature installation, block 412, interior cabinets and work surfaces are fabricated and installed, block 414. Cabinets are typically fabricated from steel, fiberglass, or other suitable materials and are permanently installed in the interior of the cargo portion of the truck.

An additional fuel tank may be installed to increase the range in which the truck can travel without refueling, block 416. The additional fuel tank also helps provide fuel for a diesel powered generator that is discussed in more detail hereinbelow.

Once the physical modifications to the truck shown in blocks 402-416 are complete, the equipment necessary for smelting and assaying may be installed, block 418. The equipment generally includes a diesel powered generator and an air compressor installed on the roof of the truck, an induction furnace with a water cooling system, an XRF analyzer, a precision scale, a rear monitor, and a cash dispenser.

The Niton X-Ray analyzer is required for determining the density of the precious metal. For transport between stops at client sites, it is typically stored in a so called Pelican™ waterproof case and kept under the work table to the right of the quenching tank.

Likewise, the Ohaus Explorer Pro scale (i.e., the precision scale) is required for determining pre and post assay weight of the precious metals received from a client. For transport between client sites, it is typically stored in a Pelican™ case and kept under the same steel work table as the XRF analyzer.

The rear monitor is used to view transaction details during the assay process. For transport between customer sites, it is stored in a black laptop case and secured to the monitor attached to the driver side wall.

Two cooling systems are fabricated and installed, block 420. A first cooling system provides cooling water to the induction furnace while a second cooling system provides water in which to cool smelted precious metal. Both cooling systems typically include water storage tanks coated with ceramic to aid in cooling and combat corrosion.

A ventilation system is used to provide fresh air to interior of the truck by removing fumes generated primarily during the smelting process, block 422. The ventilation system typically includes ventilation hatches, an interior fan and a ventilation hood. An exhaust fan also located on the roof of the truck is connected to the ventilation hood.

A safe forming a worktable on an upper surface thereof is either procured or fabricated and installed, block 424. A work bench to support both the XRF analyzer and the precision scale is also fabricated and installed.

The foregoing modifications have dealt primarily with modifications to the cargo space of the truck. Some modifications and additions are also made to the truck cabin (cab).

Thermal and rubber padding may be installed on the floor board of the truck cab, block 426. This padding limits heat generated from the truck's engine block from entering the cab.

A stand to house the truck's laptop computer and printer is fabricated and installed in the cab of the truck, block 428.

Three air seats are installed within the truck; two in the cab and one in the rear of the truck, block 430. The installation of the air seats involves fabricating a mounting plate upon which the seats are bolted. The three air seats are provided air for operation by the air compressor mounted on the truck roof.

One of the final steps towards completion of the mobile smelting and assay facility is the installation of security cameras and the support security/surveillance system required to operate them, block 432. The security/surveillance system is coupled to a communications system that allows all activities within and without the vehicle to be monitored from a remote location. The communications system also provides Internet access within the mobile facility. A radio and speaker system may also be installed in the cab of the truck.

Once the foregoing modifications are complete, complete system and functional testing begins, block 434. Testing involves verification of all electrical and electronic components necessary to conduct a mobile smelting and assaying business.

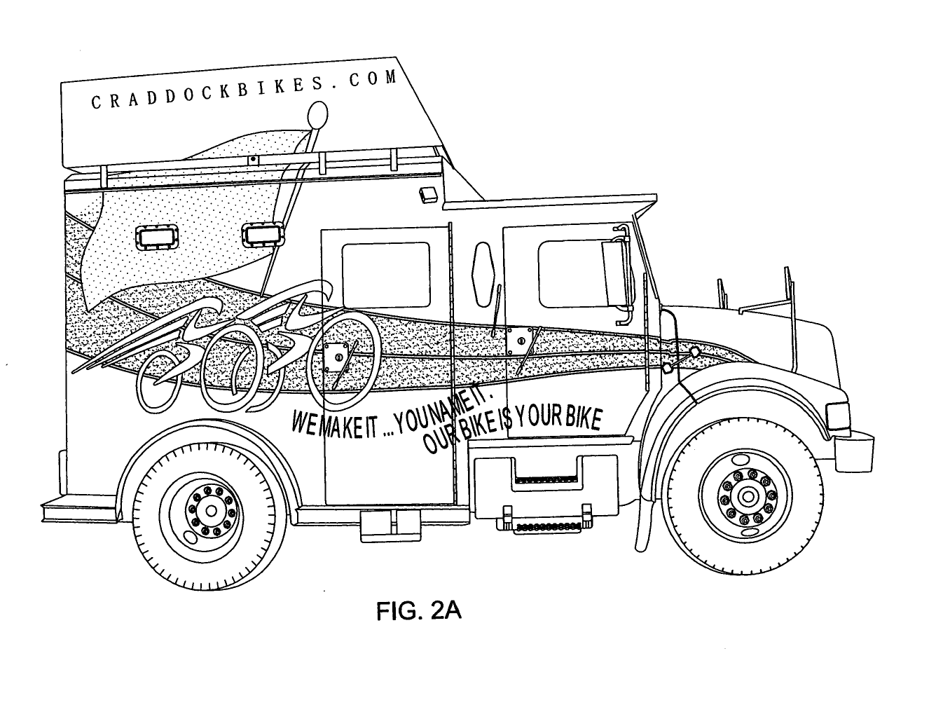

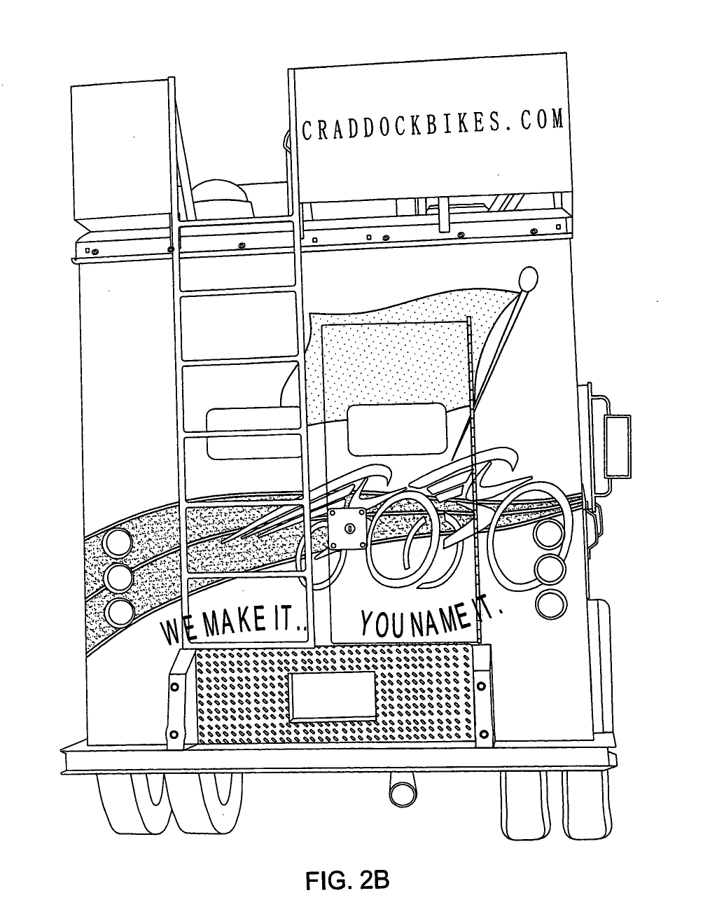

FIGS. 2a and 2b show right side and rear elevational pictorial, views of a a typical armored truck modified in accordance with the method of FIG. 1 for use as a self-contained, mobile smelting and assaying facility;

The process of conducting a mobile smelting and assaying service is now addressed. For purposes of disclosure, the method of a business model known as Assay on Wheels™ (AOW) is used. Assay on Wheels is a wholly owned subsidiary of NoyesCraddock Inc., of Chesapeake, Va. The AOW model uses a two person crew in the mobile smelting and assay facility described in detail in our included co-pending application, a driver and an assayer. The driver and assayer each perform specialized, non-interchangeable functions to insure the safety and integrity of the smelting and assaying process. The functions of each are described in detail. While a two person crew has been chosen for purposes of disclosure, it will be recognized that in alternate embodiments, the function could possibly be delegated to a single person or in still other alternate embodiments, a crew of three or more could possibly be utilized. Consequently, the method of the invention is not considered limited to a particular crew size.

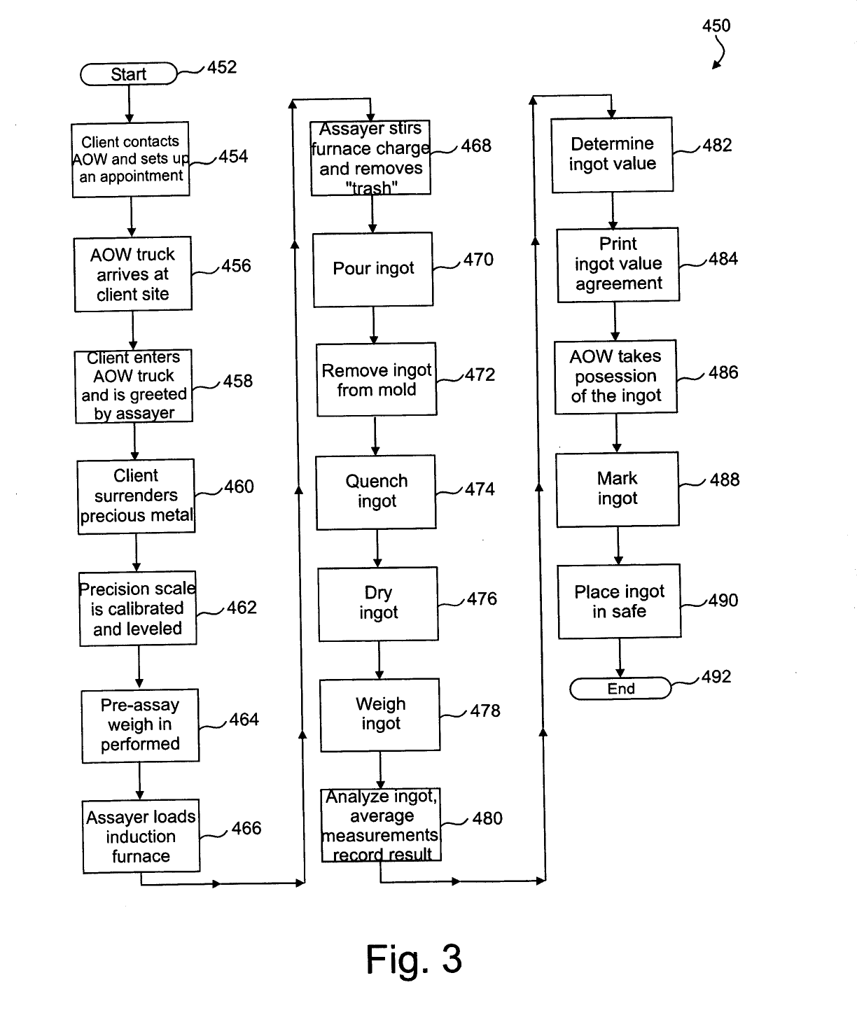

Referring now to FIG. 3, there is shown a simplified flow chart of the mobile assay process of the present invention, generally at reference number 150.

The smelting and assaying process begins, block 452, when an existing client (i.e., a seller of precious metals) or a new client contacts an AOW's office to schedule an appointment, block 454. That appointment, based on availability, will determine when an AOW truck (i.e., the mobile smelting and assaying facility) will arrive at the clients' site. As used herein, the term AOW office is

TABLE 1
ASSAY ON WHEELS - TRUCK
Quick Reference Checklist
ADMINISTRATIVE ITEMS

| | | |
|---|---|---|
| Clip Board | The clip board is vital for reviewing and signing documentation with the client | □ |
| Pens/Sharpie | Pens are required in order to sign transaction agreements with clients. Sharpies are | □ |
| | needed in order to label each precious metal bar poured. | |

EQUIPMENT

| | | |
|---|---|---|
| Nitron X-Ray | The X-Ray gun is required for determining the density of the precious metal. It is | □ |
| Gun | stored in a yellow pelican case and kept under the work table to the right of the | |
| | quenching table. | |
| Ohaus Pro Scale | The Explorer Pro scale is also required for determining pre and post assay weight. It | □ |
| | is stored in a black pelican case and kept under the same steal work table as the x-ray | |
| | gun. | |
| Rear Monitor | The rear monitor is used to view transaction details during the assay process. It is | □ |
| | stored in a black laptop case and secured to the monitor attached to the driver side | |
| | wall | |
| Cash Machine | It is important to note the amount of money being stored in the cash machine and to | □ |
| | ensure that it is locked down. The keys to the cash machine are kept by the driver. | |
| | The cash machine is found secured to the driver side wall above the safe. | |
| Quenching Tank | The quenching tank is located on the passenger side wall to the right of the entry | □ |
| | door. It is important to note that water is in the tank at all times. Without water the | |
| | assayer will be unable to cool the precious metal ingot after it's poured into the ingot | |
| | mold. | |

ASSAY TOOLS
(REQUIRED TO PROCESS PRECIOUS METAL)

| | | |
|---|---|---|
| Assayers Stool | Stool that assayer will sit on while processing precious metal. This stool is usually | □ |
| | secured to the rear door via a bungee cord. | |
| Buckets | Buckets are required for the transportation of precious metal and also to get an | □ |
| | accurate pre assay reading of the metal to be processed. The buckets are normally | |
| | located under the steal work table. | |
| Ingot Molds | Ingot molds are needed in order to develop an ingot bar from the precious metal as | □ |
| | it's still molten. The molds are located on top of the steal safe stacked in a neat pile | |
| | from largest to smallest. | |
| Gloves | Thermal gloves are used to prevent burning. They are located on the tool shelf | □ |
| | located next to the induction heater. | |
| Sleeves | Thermal sleeves are used to prevent burning. They are located on the tool shelf | □ |
| | located next to the induction heater. | |
| Channel Locks | The channel locks are used to remove the ingot from the ingot mold. They are also | □ |
| | used to transport the newly formed (and extremely hot) ingot into the quenching tank. | |
| | The channel locks are located on the tool shelf next to the induction heater. | |
| Telescopic | The telescopic mirror is used to see inside the crucible during the assay process. | □ |
| Mirror | They are located on the tool shelf next to the induction heater. | |
| Stirring Stick | The stirring stick is used to assist the molten metal in being fully stirred. The stick is | □ |
| | located on top of the safe next to the ingot molds. Extra stir sticks can be found in the | |
| | tool box accompanied by an Allen wrench for changing. | |
| Crucible | The crucible is a refractory container used to melt the precious metal. The Crucible is | □ |
| | stored in the top of the induction heater. A spare should be kept on the truck and | |
| | stored underneath the steal work table | |
| Towel | A towel is kept on board the truck to dry off the newly formed ingot after it is cooled | □ |
| | down in the quenching tank. The towel is normally stored on top of the safe. | |
| Angle Iron | The angle iron is a long piece of metal approximately 14 inches long and bent into a | □ |
| | 90 degree angle. The angle iron is used to load the precious metal from the clients | |
| | bucket to the crucible. The angle iron is stored on the tool shelf located next to the | |
| | induction heater | |
| Crucible Tongs | The tongs are a long, skinny pair of pliers designed to remove the crucible from the | □ |
| | induction heater as it's heated to over 2000 degrees. It is necessary to use the tongs | |
| | while pouring the molten metal into an ingot mold. The tongs are stored next to the | |
| | cooling tank, secured by the tanks security straps. | |

intended to refer to any one of a central AOW office, an AOW satellite office, or the office of a designated AOW agent.

The individual itineraries for the day are typically e-mailed to each of a fleet of AOW trucks operating out of a particular AOW office. The itinerary is received and printed so a hard copy is available in the AOW truck cab.

At the agreed upon time, an AOW truck arrives at the client site, block 456. Typically, the driver contacts the client when the AOW truck is a predetermined length of time prior to arriving at the client's site to alert the client of the AOW truck's arrival time.

At each stop at a client site, the assayer has certain housekeeping tasks to perform. Prior to the arrival of the client, the XRF analyzer, the precision scale, and the rear monitor must be removed from protective carrying cases and placed in their respective operational positions. Electrical connections must be made.

At the end of each client site visit, each of the aforementioned instruments must be disconnected and packed in their respective protective carrying cases prior to the AOW truck's departing the client site.

Once the AOW truck arrives at the client site, block 456, the client enters the AOW truck with precious metal they wish to sell and is greeted by the assayer, block 458. Typically, the client's precious metal is carried in a camouflaged container to minimize risk to the client as he or she moves their precious metal from their facility to the AOW truck. It is important to note the AOW truck's security system is operational at all times and the driver remains in the cab and monitors all interior and exterior cameras for any abnormalities, typically on a split screen monitor. The output of all video cameras is recorded.

The assay process begins once the precious metal has been surrendered by the client to the assayer, block 460. The client is typically invited to sit in the rear seat, the position of which is selected to provide the client a clear view of all assaying activities.

In the presence of the client, the precision scale is calibrated, typically by a so-called “zeroing out” procedure, block 462. As part of the calibration, the assayer typically checks to ensure that the precision scale is level.

Once the precision scale is properly calibrated, block 462, the assayer performs an initial, pre assay weigh-in of the precious metal received from the client, block 464.

Once the pre assay weigh-in is complete, block 464 the actual assay process begins. This process is made up of steps that result in the precious metal received from the client being smelted, cast into an ingot, and then analyzed for precious metal content.

The assayer takes position adjacent the induction heater with the precious metal received from the client, typically in a bucket at his feet. Using a length of angle iron or another suitable apparatus, the assayer begins to load the crucible with precious metal, block 466. It is assumed that the induction furnace and the ventilation system have previously been started and the crucible is ready to receive a charge (i.e., a load of precious metal to be melted).

During the loading process it is important that the assayer take precautions to avoid spillage of any of the client's precious metal. This may be done, for example, by loading the angle iron or other apparatus over the bucket to avoid accidently dropping any precious metal onto the floor of the truck. The loading process continues until either the bucket is empty or the crucible is full.

During the smelting process, the assayer stirs the charge in the crucible to ensure uniformity of the charge, block 468. Uniformity is important to insure that the subsequent XRF reading accurately reflects the overall metal content of the ingot being analyzed. The precious metal poured into the crucible may contain materials that do not melt at the temperature the induction furnace is operated. Stirring also helps separate these materials from the crucible charge and may be removed, block 468.

Once the precious metal is melted in the crucible, has been adequately stirred and any “trash” removed, block 468, the precious metal is poured into an ingot mold by grasping the crucible with the tongs, removing the crucible from the induction furnace, and executing the pour, block 470. The size of the ingot mold chosen depends on the volume of melted precious metal to be poured. This is typically estimated from the pre assay weigh-in. It's important to note that during the pre assay weigh-in that if the precious metal weighs over approximately 3500 grams that the mass of the molten metal will be greater than the capacity of the large ingot mold and multiple ingots must be poured.

Once poured, block 470, the ingot is air cooled until it may be removed from the ingot mold, block 472. Once removed from the ingot mold, the newly formed ingot will still be approximately 2000° f. To rapidly cool the ingot, the assayer transports the ingot to the quenching tank using the Channel Lock® pliers or another suitable tool, block 474.

Once cooled in the quenching tank the ingot must be dried, block 476 prior to being placed on the precision scale for a post assay weigh-in, block 478.

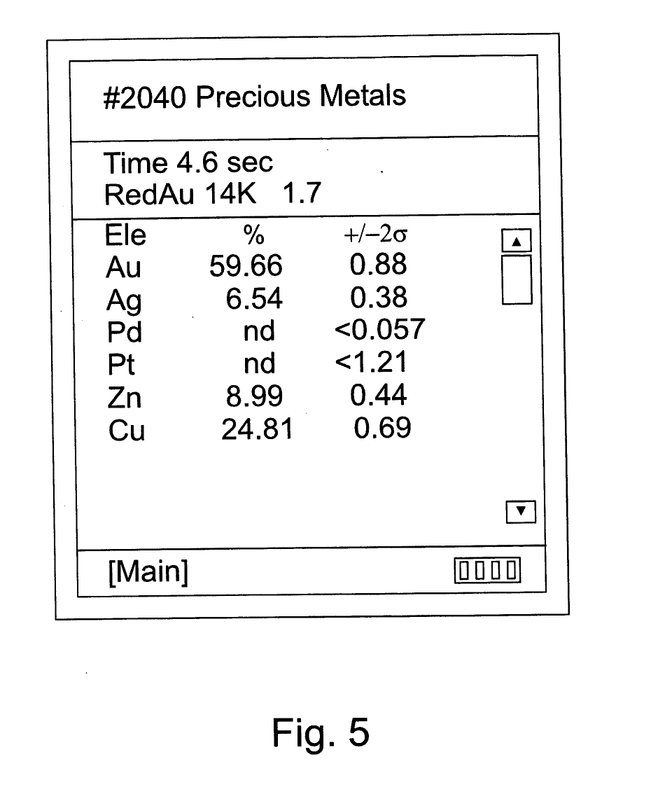

Once weighed, block 478, the ingot is then placed into the Niton X-Ray analyzer stand. The Niton X-ray fluorescence (XRF) analyzer is operatively connected to a computer, either to the laptop computer in the cab or to an optional second laptop computer in the rear portion of the AOW truck. The computer is used to make several successive measurements (i.e., “shots”) at various positions on the ingot, block 480. The results of these multiple measurement are averaged to arrive at an analysis of the ingot, that is, the percentage of certain precious metal components present in the ingot. FIG. 5 shows a computer screen shot of an analysis of a typical smelted ingot.

The ingot weight and purity is next used to calculate an ingot value. This is accomplished using the post smelting weight and purity. The resulting values are entered into an AOW pre-populated spreadsheet which calculates the value of the ingot based on current market values of one or more of the component precision metals, block 482.

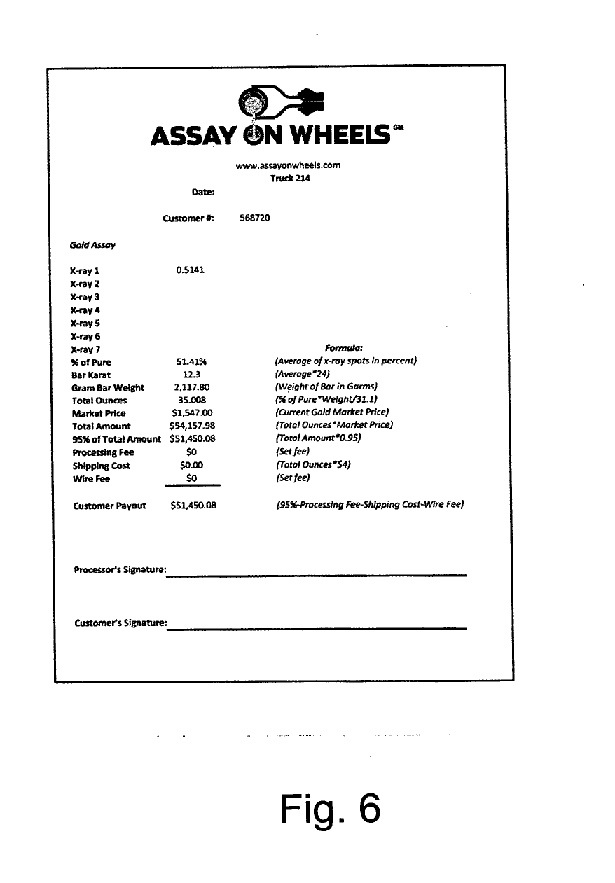

Next, the pre-populated spreadsheet is used to print a value agreement using the printer in the truck cab. Two copies of the value agreement are printed and each signed by both the client and the assayer, each retaining a copy, block 484. A sample value agreement is shown in FIG. 6.

Once the value agreement has been signed by the client the assayer, AOW will take posession of the ingot, block 486. The assayer may mark the ingot with indicia including such information as the customer and date of the transaction, block 488. Once marked, the ingot may be placed in the truck's safe, block 490.

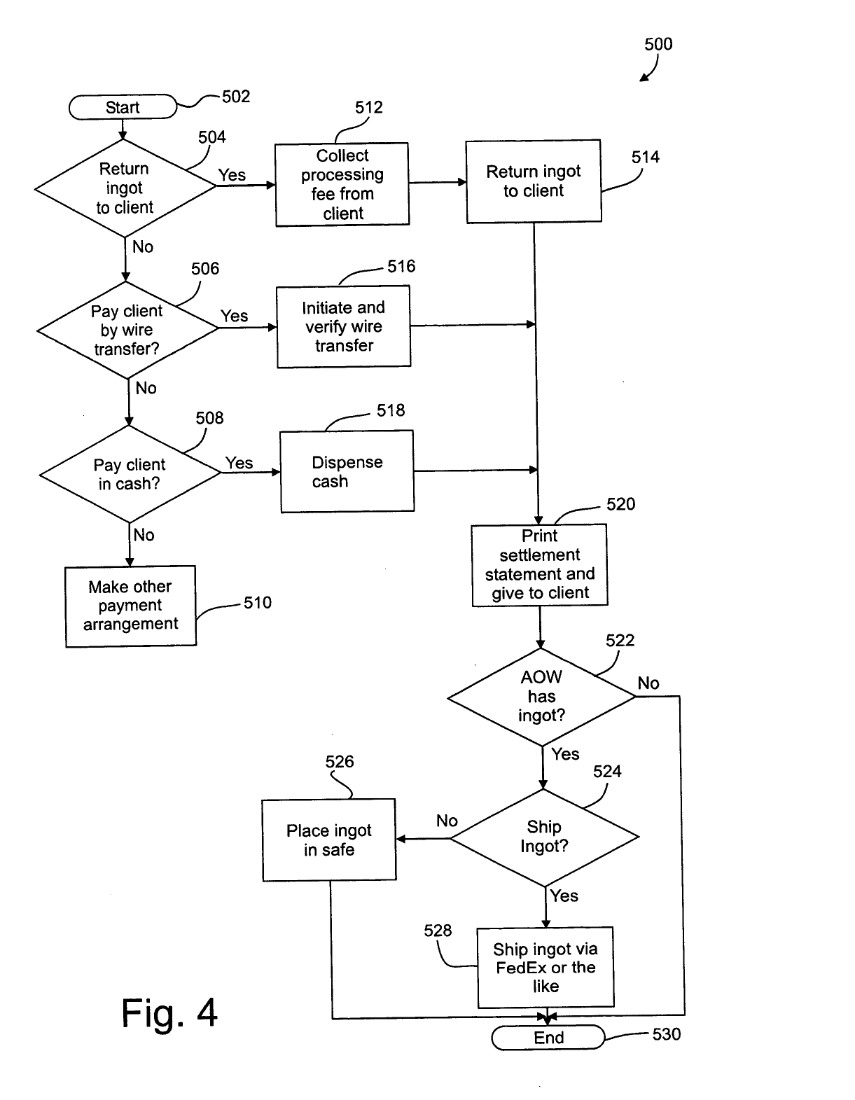

The assay process then ends, block 492. At this point, however, to complete the process, the client must be paid for the precious metal surrendered to AOW. Referring now also to FIG. 4, there is shown a flow chart of the payment process, generally at reference number 500.

Once the assay process is complete, the payment process is started, block 502. One possibility is that the client may choose to have the ingot be returned, block 504. If the client so chooses, block 504, a processing fee may be collected from the client, block 512 and the ingot returned to the client, block 514. A settlement statement is printed and given to the client, block 520.

As AOW no longer has the ingot, block 522, the payment process is terminated, block 530.

If, however, the client does not wish to have the ingot returned, block 504, the client may wish to be paid for the precious metal by wire transfer, block 506. If so, a wire transfer is initiated and verified from within the self-contained, mobile smelting and assaying facility, block 516. Once the wire transfer is verified, block 516, a settlement statement is printed for the client, block 520.

As AOW still possesses the ingot, block 522, a decision is made regarding its disposition, block 524. The ingot may be shipped, block 524. If it is decided to ship the ingot, block 524, the driver prepares shipping labels and the ingot is packaged, typically in a turtle box, security seals are applied, the turtle box is packaged in a FedEx® shipping box, and the shipping label is applied. The FedEx® box may then be deposited at any FedEx® collection box, agency, or depot, block 528. The process then terminates, block 530.

If the ingot is not shipped, block 524, it is placed in the safe, block 526, and the process terminates, block 530.

As mentioned hereinabove, the AOW model uses a two person crew, a driver and an assayer. The role of the driver is now discussed.

The driver has responsibility for all aspects of the AOW mobile smelting and assaying facility. There are several defined procedures to be followed by the driver to ensure that the AOW armored truck is fully prepared for a day of precious metal pickup activities.

Typically the driver initiates a startup procedure in the morning that includes starting the truck's engine to ensure that all engine functions appear to be normal.

The driver is also responsible to ensuring that the AOW truck has adequate diesel fuel on board for the day's itinerary and anticipated generator operation.

Typically the driver performs a complete truck inspection during the startup phase. The driver is, for example, expected to ensure that all exterior and interior lights are functioning properly. The driver also inspects the exterior of the truck for any damage or other obvious maintenance issues. If damage is found on the exterior of the truck, or maintenance is required, the driver makes a log entry into his or her daily report and notifies an appropriate AOW office.

Further, the driver will make sure that all dome lights and door pops are in good working condition.

Once a week, the driver will check all truck and generator fluids and add any necessary fluid when required to ensure peak truck and generator performance.

The driver must climb to the top of the truck. Once on the roof the driver places the generator key in the generator and turns the key to the ‘remote’ position. The driver will also turn on the air compressor. Note: The air compressor must be drained once per week.

When the rooftop activities are complete, the driver turns on the power converter, thereby giving the driver the ability to turn on the computer (i.e., the laptop) and printer to ensure that both are working properly.

Once the computer is booted up, the driver checks the trucks email for the day's itinerary and other instructions issued by an AOW office. To check the printer, the driver prints a copy of the daily route and places it on a daily report clipboard to assist in navigation.

Before departure the driver must make sure that adequate paper and ink supplies are available on the truck to meet the day's anticipated demands.

The driver also checks all security/surveillance equipment, ensuring that it is on and properly recording. All cameras (typically four) are individually checked to ensure each is in working order (i.e., is turned on, correctly aimed, the lens is clean and unobstructed by debris)

The driver checks that induction furnace is off and that water levels in both the quenching and cooling tanks are at required levels. If water is required, the driver brings the water level up to the required level.

The driver must also verify that proper shipping supplies are on hand to ship out precious metal at the end of the day. Materials include, but may not be limited to, FedEx® priority boxes, turtle boxes, seals, packing material and packing tape, and all must be on board prior to departure.

The final check the driver typically makes prior to departure is to ensure that the generator and induction furnace are properly operating.

The generator is started from the cab (assuming that the generator key is in the necessary remote position) using procedures specific to the generator on the particular AOW truck. Once the generator has been engaged, and has been running for longer than 30 seconds, the induction furnace is checked for proper operation. This check includes a check of the induction furnace cooling system to verify proper flow of cooling water to the induction furnace. Typically, the driver will also check the ventilation system for proper operation and that the smoke/carbon monoxide detector is functioning by pressing the test button.

Once these checks are accomplished, the generator is shut down following specific shutdown procedures for the generator.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A method for mobile collection, smelting, and assaying of precious metal, the steps comprising:
providing a secure, self contained mobile smelting and assaying facility comprising a vehicle having a cab portion and an open cargo portion, said open cargo portion containing at least a precision scale, means for smelting precious metal, including a crucible, an induction furnace, an ingot mold, a quenching tank, a ventilation system comprising ventilation hatches, an interior fan, a ventilation hood, an induction furnace cooling system, an exhaust fan connected to said ventilation hood, a diesel powered generator having power control in the cab of said vehicle, said diesel powered generator powering said indiction furnace, an auxiliary fuel tank with conduit configured to power said diesel powered generator, a telescopic mirror, means for assaying precious metal, including an X-ray fluorescence (XRF) analyzer operatively connected to a computer, means for determining a value of a particular precious metal of interest, means for paying for precious metal received at said self contained mobile smelting and assaying facility, security and surveillance cameras, and a seat for a seller to sit on to view the collection, smelting, and assaying of said precious metal;
moving said mobile smelting and assaying facility to a site where precious metal is being offered for sale by said seller;
accepting said precious metal offered for sale from said seller in said open cargo portion of said mobile smelting and assaying facility;
calibrating and leveling said precision scale, wherein said calibrating and leveling are performed in view of said seller present in said open cargo portion;
pouring said precious metal into said crucible, wherein said pouring is performed in view of said seller present in said open cargo portion;
stirring said precious metal in said crucible, to ensure uniformity of said precious metal, wherein said stirring is performed in view of said seller present in said open cargo portion;
separating and removing materials in said crucible that do not melt at a temperature said induction furnace is operated, wherein said separating is performed in view of said seller present in said open cargo portion;
accurately weighing said ingot using said precision scale, wherein said weighing is performed in view of said seller present in said open cargo portion;
analyzing said ingot, wherein said analyzing determines a percentage of certain precious metal components of said ingot, wherein said analyzing is performed in view of said seller present in said open cargo portion;
determining, utilizing said computer, wherein said computer is configured to calculate based on a current market value of said percentage of certain precious metal components of said ingot, a determined value of said at least one particular precious metal component of interest, wherein said determining is performed in view of said seller present in said open cargo portion; and
paying said seller said determined value while said seller remains in said open cargo portion.

2. The method for mobile collection, smelting, and assaying of precious metal as recited in claim 1, the steps further comprising:
performing one of the actions selected from the group: storing said smelted precious metal in a safe within said mobile smelting and assaying facility, and shipping said smelted precious metal to a processor thereof directly from said mobile smelting and assaying facility.

3. The method for mobile collection, smelting, and assaying of precious metal as recited in claim 1, the steps further comprising:
after said accepting step and prior to said pouring step,
performing pre assay weighing of said precious metal using said precision scale, in view of said seller present in said open cargo portion.

4. The method for mobile collection, smelting, and assaying of precious metal as recited in claim 1, wherein said smelting step (d) comprises the sub-steps, which are performed in view of said seller present in said open cargo portion:
pouring said precious metal into said ingot mold and forming an ingot;
air cooling said ingot;
rapidly cooling said ingot in said quenching tank;
removing said ingot from said ingot mold;
drying said ingot.

5. The method for mobile collection, smelting, and assaying of precious metal as recited in claim 1, wherein the steps: calibrating, performing pre assay weighing, pouring said precious metal into said crucible, stirring, separating and removing, pouring said precious metal into said ingot mold, air cooling, rapidly cooling said ingot, removing said ingot from said ingot mold, drying said ingot, accurately weighing said ingot, analyzing said ingot are performed in view of said seller present in said open cargo portion.

6. The method for mobile collection, smelting, and assaying of precious metal as recited in claim 1, wherein said providing step comprises providing a vehicle comprising a modified armored truck and said moving step comprises driving said armored truck to a site where precious metal is being offered for sale by a seller.

7. The method for mobile collection, smelting, and assaying of precious metal as recited in claim 1, wherein said determining a value of said at least one particular precious metal component of interest step comprises determining a current market value of said at least one particular precious metal component of interest.

8. The method for mobile collection, smelting, and assaying of precious metal as recited in claim 7, wherein said determining a current market value of said at least one particular precious metal component of interest is performed in real time from within said mobile smelting and assaying facility.

9. The method for mobile collection, smelting, and assaying of precious metal as recited in claim 1, wherein said analyzing comprises making several successive measurements, using said (XRF) analyzer, at various positions on said ingot, wherein said computer is configured to compute an analysis of said ingot, comprising a percentage of certain precious metal components of said ingot.

10. The method for mobile collection, smelting, and assaying of precious metal as recited in claim 1, wherein said paying step comprises the sub-step: optionally deducting at least an assaying fee from said determined value prior to paying said seller.

11. The method for mobile collection, smelting, and assaying of precious metal as recited in claim 10, wherein said paying said seller step comprises the substep:
paying said seller by at least one of the methods selected from the group: returning said precious metal, paying cash, paying by wire transfer, and paying by another payment method.

12. The method for mobile collection, smelting, and assaying of precious metal as recited in claim 11, wherein said paying said seller step comprises the substep:
when paying cash, paying said seller by paying cash dispensed by a cash dispensing apparatus.

13. The method for mobile collection, smelting, and assaying of precious metal as recited in claim 11, wherein said paying said seller step comprises the substep:
when by wire transfer, initiating a wire transfer from within said mobile smelting and assaying apparatus.

14. A method for constructing a mobile smelting and assay facility, the steps comprising:
a) procuring an armored truck, said armored truck comprising a cab portion, a cargo portion, and a roof;
b) modifying said armored truck by performing the sub-steps:
i) removing interior roof panels, wall, panels, and other interior structural features from a cargo portion of said armored truck;
ii) raising said roof of said armored truck;
iii) installing an upper skirt on said roof;
c) preparing the exterior of said armored truck;
d) installing wall features, ceiling features, cabinets, and work surfaces in said cargo portion of said armored truck;
e) installing smelting and assaying equipment in said cargo portion and on said roof of said armored truck;
f) installing a cooling system and a ventilation system in said cargo portion of said armored truck; and
g) installing a security and communication system in said armored truck.

15. The method for constructing a mobile smelting and assay facility as recited in claim 14, wherein said installing smelting and assaying equipment step (e) comprises:
installing a diesel powered generator and an air compressor on said roof.

16. The method for constructing a mobile smelting and assay facility as recited in claim 14, the steps further comprising:
h) wrapping said prepared armored truck body with a sticker wrap having indicia included thereupon.

17. The method for constructing a mobile smelting and assay facility as recited in claim 16, wherein said wrapping step (h) comprises wrapping said prepared armored truck body with a sticker wrap having indicia comprising at least one selected from the group:
advertising, misleading indicia to disguise the function of said truck as a mobile smelting and assay facility, and company information including contact information.

18. The method for constructing a mobile smelting and assay facility as recited in claim 14, the steps further comprising:
h) adding an auxiliary fuel tank to said armored truck.

19. The method for constructing a mobile smelting and assay facility as recited in claim 14, the steps further comprising:
h) fabricating and installing a safe in said cargo portion of said armored truck.

20. The method for constructing a mobile smelting and assay facility as recited in claim 14, the steps further comprising:
h) adding at least one selected from the group: thermal insulation, and rubber padding to a portion of the floor of said cab portion of said armored truck.

21. The method for constructing a mobile smelting and assay facility as recited in claim 14, the steps further comprising:
h) installing a support stand for at least a computer and a printer in said cab portion of said armored truck.

22. The method for constructing a mobile smelting and assay facility as recited in claim 21, wherein said installing step (h) comprises the sub-step: fabricating said support stand.

23. The method for mobile collection, smelting, and assaying of precious metal as recited in claim 1, the steps further comprising:
improving said seller's view of said crucible wherein said telescopic mirror provides said seller visual access to the inside of said crucible.

24. The method for mobile collection, smelting, and assaying of precious metal as recited in claim 1, the steps further comprising:
following said paying step, cooling said induction furnace, utilizing said induction furnace cooling system, wherein said induction furnace cooling system includes plumbing comprising pipes and valves to allow flow of cool water through said induction furnace, and wherein said plumbing is equipped to introduce compressed air to purge all lines when necessary to prevent damage due to freezing.

25. The method for mobile collection, smelting, and assaying of precious metal as recited in claim 1, the steps further comprising:
prior to said accepting step and continuing through said paying step:
visually monitoring, utilizing said security and surveillance cameras, all activities within said open cargo portion relating to collection, smelting, and assaying of said precious metal; and
recording said activities within said open cargo portion, utilizing a digital video recorder and transmitting said recording of said activities within said open cargo portion to a base of operations remote from said mobile facility.

26. The method for mobile collection, smelting, and assaying of precious metal as recited in claim 1, the steps further comprising:
prior to said accepting step and continuing through said paying step:
visually monitoring, utilizing said security and surveillance cameras, all activities outside said mobile facility; and
recording said activities outside said mobile facility, utilizing a digital video recorder and transmitting said recording of said activities outside said mobile facility to a base of operations remote from said mobile facility.

27. The method for mobile collection, smelting, and assaying of precious metal as recited in claim 1, the steps further comprising:
prior to said accepting step and continuing through said paying step:
ventilating, utilizing said ventilation system, in order to change the entire volume of air within said open cargo portion every 15 seconds.

28. The method for mobile collection, smelting, and assaying of precious metal as recited in claim 1, the steps further comprising:
performing all steps following said accepting step in the presence of said seller.
